(19) United States
(12) Patent Application Publication
(10) Pub. No.: US 2021/0248442 A1
(43) Pub. Date: Aug. 12, 2021

(54) COMPUTING DEVICE AND METHOD USING A NEURAL NETWORK TO PREDICT VALUES OF AN INPUT VARIABLE OF A SOFTWARE

(71) Applicant: Distech Controls Inc., Brossard (CA)

(72) Inventor: Francois GERVAIS, Lachine (CA)

(21) Appl. No.: 16/787,431

(22) Filed: Feb. 11, 2020

(51) Int. Cl. G06N 3/04; G06N 3/08

(52) U.S. Cl. CPC G06N 3/0427; G06N 3/08; G06N 3/0445

(57) ABSTRACT

Computing device and method using a neural network to predict values of an input variable of a software. Computing device determines an initial series of n consecutive values of the input variable and then performs an iterative process, which includes using the neural network for inferring a next value of the input variable based at least on the series of n consecutive values of the input variable. Iterative process includes executing the software, using the next value of the input variable to calculate a corresponding next value of an output variable. Iterative process includes updating the series of n consecutive values by removing the first value among the series of n consecutive values and adding the next value as the last value of the series of n consecutive values. Iterative process may include determining that a condition is met based at least on the next value of the output variable.

### TECHNICAL FIELD

The present disclosure relates to the field of artificial intelligence applied to software simulation and testing. More specifically, the present disclosure presents a computing device and method using a neural network to predict values of an input variable of a software.

### BACKGROUND

A software comprises a set of instructions executable by a processor of a computing device. The software uses one or more input variable and generates one or more output variable. The execution of the instructions of the software by the processor calculates the value of the one or more output variable based on the value of the one or more input variable.

An example of such a software in the context of environment control systems is a software executed by an environment controller. The software uses one or more environmental characteristic value collected by sensor(s) and generates one or more command for controlling appliance(s).

Before deploying the software in operational conditions, testing and/or simulation of the software is usually performed. The testing and simulation procedures allow to discover and correct bugs in the software, to improve the functionalities of the software, etc. For example, a plurality of iterations of the execution of the software are performed, to determine how the evolution over time of the value of an input variable impacts the evolution over time of an output variable.

For this purpose, a series of consecutive values of the input variable is generated and used by the software. However, in order for the software to be tested in a realistic manner, the series of consecutive values shall be representative of the evolution of the input variable in the operational conditions. For example, if the input variable represents a temperature measured by a sensor in a room, then the series of values used for testing the software shall be representative of an evolution of the temperature in the room over a period of time.

Therefore, there is a need for a computing device and method using a neural network to predict values of an input variable of a software.

### SUMMARY

According to a first aspect, the present disclosure relates to a computing device. The computing device comprises memory and a processing unit. The memory stores a predictive model comprising weights of a neural network. The memory also stores instructions of a software, the software using an input variable for calculating an output variable. The processing unit is configured to determine an initial series of n consecutive values (x₁), (x₂) . . . (xₙ) of the input variable, n being an integer greater or equal than 2. The processing unit is configured to perform one or more iteration of an iterative process. The iterative process includes executing a neural network inference engine. The neural network inference engine implements a neural network using the predictive model for inferring one or more output parameter based on input parameters. The one or more output parameter comprises a next value of the input variable. The input parameters comprise the series of n consecutive values of the input variable. The iterative process further includes executing the instructions of the software using the next value of the input variable to calculate a corresponding next value of the output variable. The iterative process further includes updating the series of n consecutive values of the input variable by removing the first value among the series of n consecutive values and adding the next value as the last value of the series of n consecutive values.

According to a second aspect, the present disclosure relates to a method using a neural network to predict values of an input variable of a software. The method comprises storing in a memory of a computing device a predictive model comprising weights of the neural network. The method comprises storing in the memory of the computing device instructions of the software, the software using the input variable for calculating an output variable. The method comprises determining by a processing unit of the computing device an initial series of n consecutive values (x₁), (x₂) . . . (xₙ) of the input variable, n being an integer greater or equal than 2. The method comprises performing by the processing unit of the computing device one or more iteration of an iterative process. The iterative process includes executing a neural network inference engine. The neural network inference engine implements the neural network using the predictive model for inferring one or more output parameter based on input parameters. The one or more output parameter comprises a next value of the input variable. The input parameters comprise the series of n consecutive values of the input variable. The iterative process further includes executing the instructions of the software using the next value of the input variable to calculate a corresponding next value of the output variable. The iterative process further includes updating the series of n consecutive values of the input variable by removing the first value among the series of n consecutive values and adding the next value as the last value of the series of n consecutive values.

According to a third aspect, the present disclosure relates to a non-transitory computer program product comprising instructions executable by a processing unit of a computing device, the execution of the instructions by the processing unit providing for using a neural network to predict values of an input variable of a software by implementing the aforementioned method.

In a particular aspect, the iterative process further includes determining that a condition is met based at least on the next value of the output variable.

### BRIEF DESCRIPTION OF THE DRAWINGS

Embodiments of the disclosure will be described by way of example only with reference to the accompanying drawings, in which:

FIGS. 1 and 2 illustrate hardware and software components of a computing device;

FIGS. 3A and 3B illustrate a method implemented by the computing device of FIG. 1 and using a neural network to predict values of an input variable of a software;

FIG. 4 is a schematic representation of a neural network inference engine executed by the computing device of FIG. 1 according to the method of FIGS. 3A and 3B;

FIG. 5 is a detailed representation of a neural network with fully connected hidden layers;

FIG. 6 represents input and output variables of a target software executed according to the method of FIGS. 3A and 3B; and

FIG. 7 is another schematic representation of a neural network inference engine executed by the computing device of FIG. 1.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to the testing or simulation of a software using at least one input variable and calculating at least one output variable. A neural network is used for iteratively generating a plurality of consecutive values of the input variable. The generated values of the input variable are used for calculating corresponding values of the output variable of the software. For example, this procedure is used in the context of a software providing environment control functionalities.

The following terminology is used throughout the present specification:
Environment: condition(s) (temperature, pressure, oxygen level, light level, security, etc.) prevailing in a controlled area or place, such as for example in a building.
Environment control system: a set of components which collaborate for monitoring and controlling an environment.
Environmental data: any data (e.g. information, commands) related to an environment that may be exchanged between components of an environment control system.
Environment controller: device capable of receiving information related to an environment and sending commands based on such information.
Environmental characteristic: measurable, quantifiable or verifiable property of an environment (a building). The environmental characteristic comprises any of the following: temperature, pressure, humidity, lighting, CO2, flow, radiation, water level, speed, sound; a variation of at least one of the following, temperature, pressure, humidity and lighting, CO2 levels, flows, radiations, water levels, speed, sound levels, etc., and/or a combination thereof.
Environmental characteristic value: numerical, qualitative or verifiable representation of an environmental characteristic.
Sensor: device that detects an environmental characteristic and provides a numerical, quantitative or verifiable representation thereof. The numerical, quantitative or verifiable representation may be sent to an environment controller.
Controlled appliance: device that receives a command and executes the command. The command may be received from an environment controller.
VAV appliance: a Variable Air Volume appliance is a type of heating, ventilating, and/or air-conditioning (HVAC) system. By contrast to a Constant Air Volume (CAV) appliance, which supplies a constant airflow at a variable temperature, a VAV appliance varies the airflow at a constant temperature.

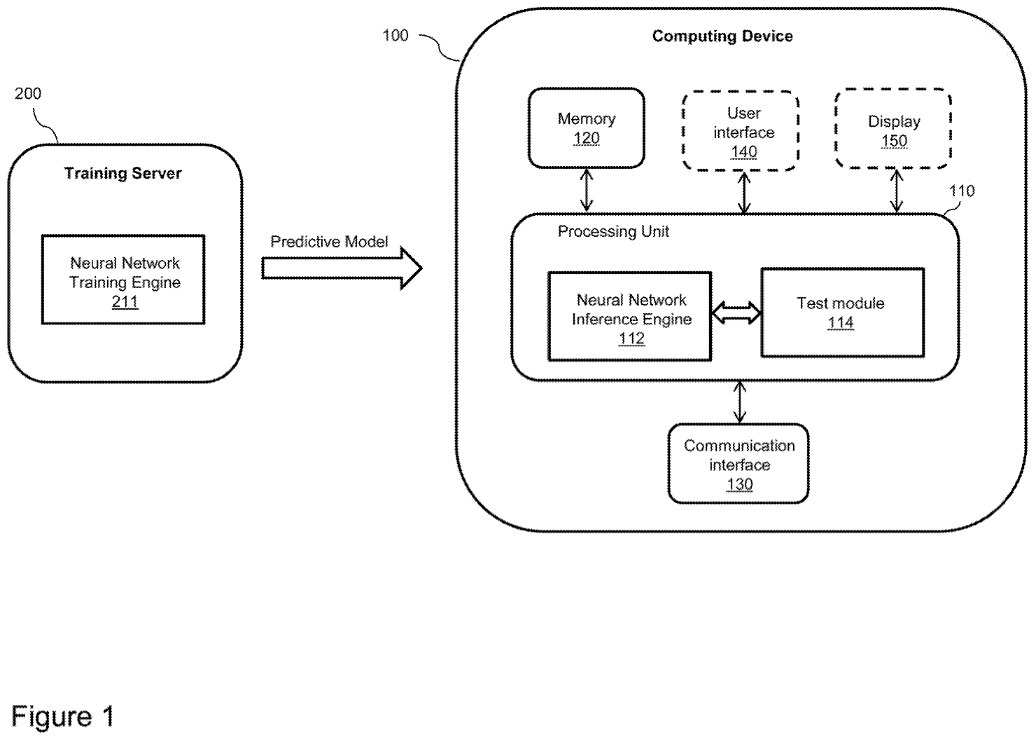

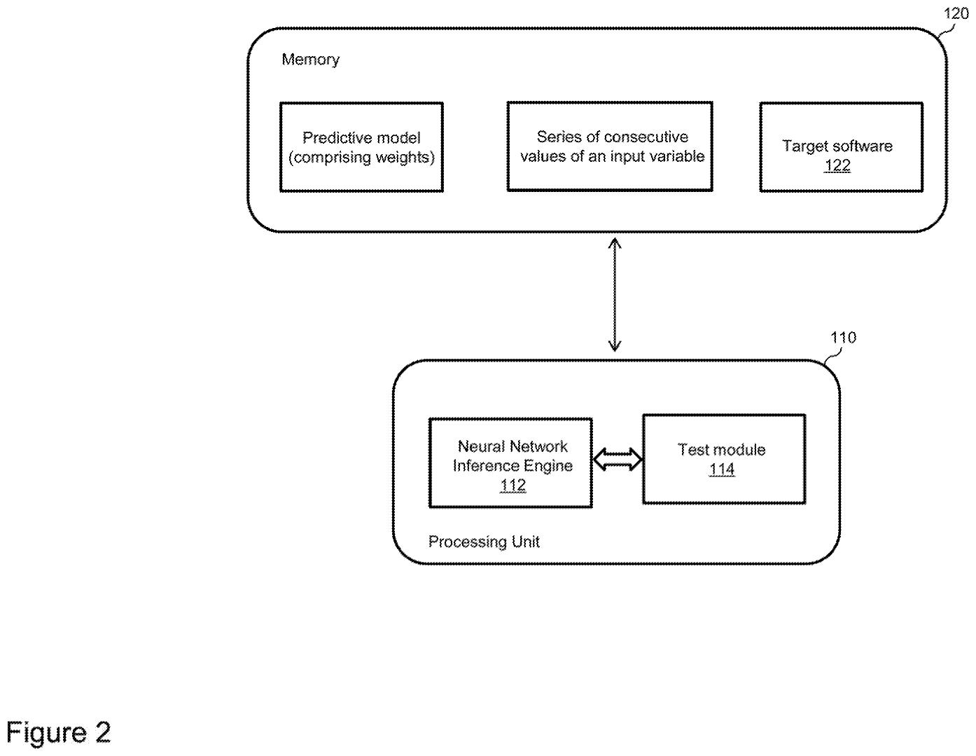

Reference is now made concurrently to FIGS. 1 and 2, where FIG. 1 represents a computing device 100 and FIG. 2 represents components of the computing device 100.

The computing device 100 comprises a processing unit 110, memory 120, and a communication interface 130. The computing device 100 may comprise additional components such as a user interface 140, a display 150, and an additional user interface (not represented in FIG. 1). Examples of computing devices 100 include a desktop, a laptop, a server in a cloud infrastructure, a tablet, etc.

The processing unit 110 comprises one or more processor capable of executing instructions of a computer program. Each processor may further comprise one or several cores. The processing unit 110 executes a neural network inference engine 112 and a test module 114, as will be detailed later in the description.

The memory 120 stores instructions of computer program(s) executed by the processing unit 110, data generated by the execution of the computer program(s), data received via the communication interface 130, etc. Only one single memory 120 is represented in FIG. 1, but the computing device 100 may comprise several types of memories, including volatile memory (such as a volatile Random Access Memory (RAM), etc.) and non-volatile memory (such as an electrically-erasable programmable read-only memory (EEPROM), flash, a hard drive, etc.).

The communication interface 130 allows the computing device 100 to exchange data with remote devices (e.g. a training server 200, etc.) over a communication network (not represented in FIG. 1 for simplification purposes). For example, the communication network is a wired communication network, such as an Ethernet network; and the communication interface 130 is adapted to support communication protocols used to exchange data over the Ethernet network. Other types of wired communication networks may also be supported by the communication interface 130. In another example, the communication network is a wireless communication network, such as a Wi-Fi network; and the communication interface 130 is adapted to support communication protocols used to exchange data over the Wi-Fi network. Other types of wireless communication network may also be supported by the communication interface 130, such as a wireless mesh network, Bluetooth®, Bluetooth® Low Energy (BLE), cellular (e.g. a 4G or 5G cellular network), etc. Optionally, the computing device 100 comprises more than one communication interface 130, and each one of the communication interfaces 130 is dedicated to the exchange of data with specific type(s) of device(s).

The optional user interface 140 may take various forms, such as a keyboard, a mouse, a tactile user interface integrated to the display 150, etc. The optional display 150 may also take various forms in terms of size, form factor, etc.

A detailed representation of the components of the training server 200 is not provided in FIG. 1 for simplification purposes. The training server 200 comprises a processing unit, memory and a communication interface. The processing unit of the training server 200 executes a neural network training engine 211. The execution of the neural network training engine 211 generates a predictive model, which is transmitted to the computing device 100 via the communication interface of the training server 200. The predictive model is transmitted over a communication network and received via the communication interface 130 of the computing device 100. The predictive model comprises weights of a neural network implemented by the neural network training engine 211 and the neural network inference engine 112.

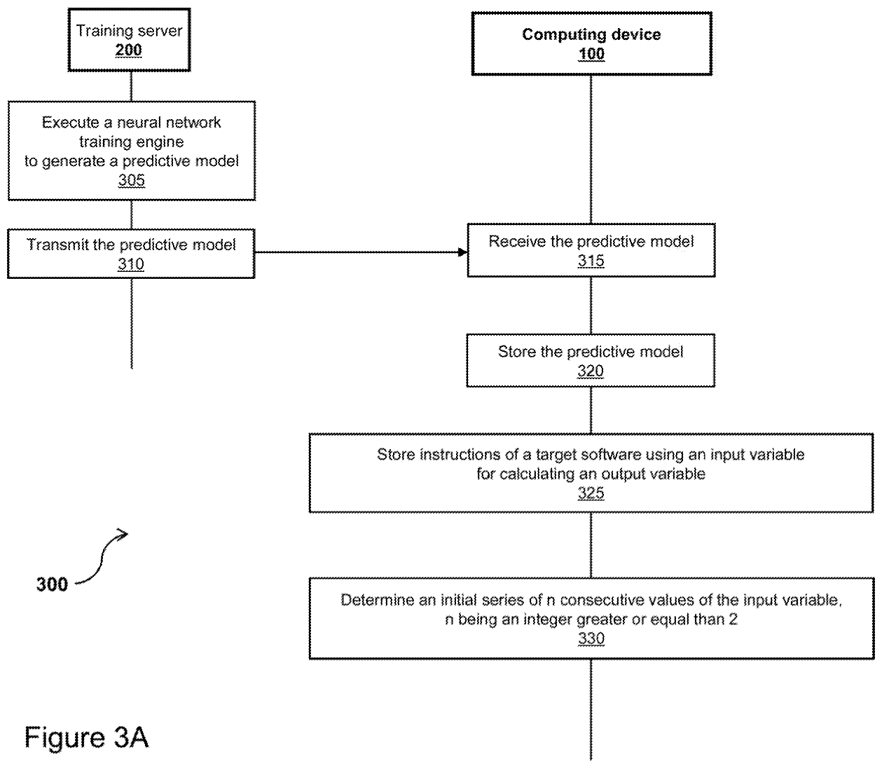

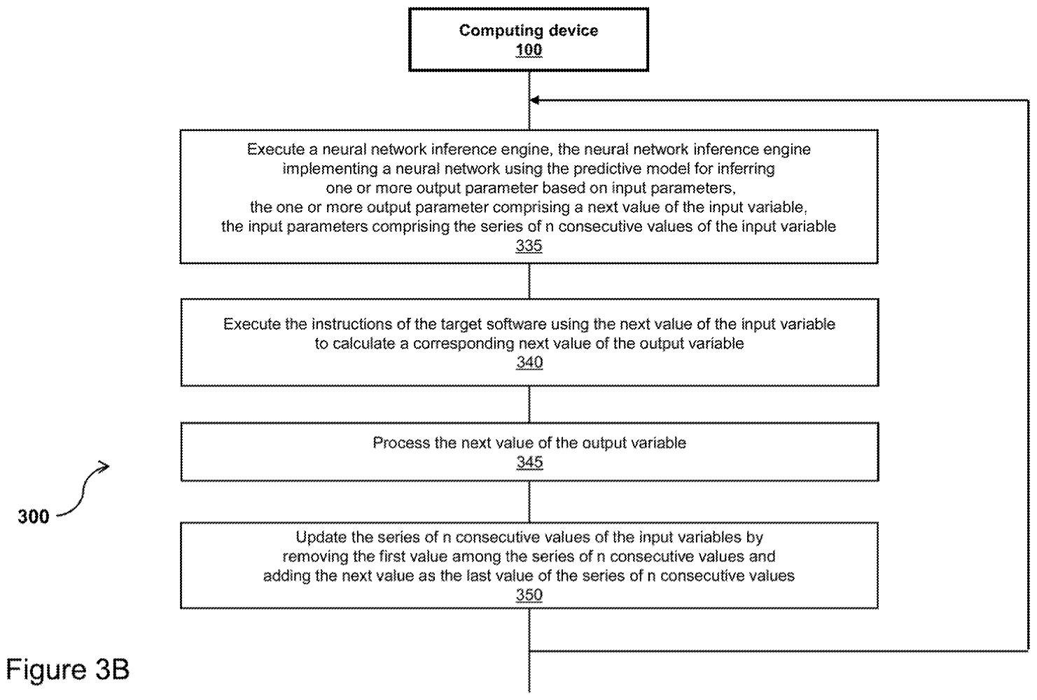

Reference is now made concurrently to FIGS. 1, 2, 3A and 3B. FIG. 2 represents details of the memory 120 and the processing unit 110 represented FIG. 1. FIGS. 3A and 3B illustrate a method 300 using a neural network to predict values of an input variable of a software. At least some of the steps of the method 300 are implemented by the computing device 100.

A dedicated computer program has instructions for implementing at least some of the steps of the method 300. The instructions are comprised in a non-transitory computer program product (e.g. stored in the memory 120) of the computing device 100. The instructions provide for using a neural network to predict values of an input variable of a software, when executed by the processing unit 110 of the computing device 100. The instructions are deliverable to the computing device 100 via an electronically-readable media such as a storage media (e.g. USB key, etc.), or via communication links (e.g. via a communication network through the communication interface 130). The computer program may include a plurality of modules, which in combination implement the functionalities of the method 300 when executed by the processing unit 110.

The instructions of the dedicated computer program executed by the processing unit 110 implement the neural network inference engine 112 and the test module 114. The neural network inference engine 112 provides functionalities of a neural network, allowing to infer output(s) based on inputs using the predictive model stored in the memory 120, as is well known in the art. The test module 114 provides functionalities for testing a software which will be referred to as the target software 122 in the following.

For differentiation purposes, the input(s) and output(s) of the target software 122 are referred to as input variable(s) and output variable(s); while the inputs and the output(s) of the neural network inference engine 112 are referred to as input parameters and output parameter(s).

As illustrated in FIG. 2, the memory 120 stores the predictive model and a series of consecutive values of an input variable (detailed later in the description), which are used by the neural network inference engine 112. The memory 120 also stores the instructions of the target software 122. The test module 114 controls the execution of the instructions of the target software 122 by the processing unit 110, to provide functionalities for testing the target software 122. The test module 114 also creates and updates the series of consecutive values of the input variable (using outputs generated by the neural network inference engine 112 as will be detailed later in the description).

The method 300 comprises the step 305 of executing the neural network training engine 211 to generate the predictive model. Step 305 is performed by the processing unit of the training server 200. This step will be further detailed later in the description.

The method 300 comprises the step 310 of transmitting the predictive model generated at step 305 to the computing device 100, via the communication interface of the training server 200. Step 310 is performed by the processing unit of the training server 200.

The method 300 comprises the step 315 of receiving the predictive model from the training server 200, via the communication interface 130 of the computing device 100. Step 315 is performed by the processing unit 110 of the computing device 100.

The method 300 comprises the step 320 of storing the predictive model in the memory 120 of the computing device 100. Step 320 is performed by the processing unit 110 of the computing device 100.

The method 300 comprises the step 325 of storing the instructions of the target software 122 in the memory 120 of the computing device 100. The target software 122 uses an input variable (referred as (x) in the rest of the description) for calculating an output variable (referred as (y) in the rest of the description). Step 325 is performed by the processing unit 110 of the computing device 100. As will be illustrated later in the description, the target software 122 may use more than one input variable and/or generated more than one output variable.

The method 300 comprises the step 330 of determining an initial series of n consecutive values (x₁), (x₂) . . . (xₙ) of the input variable, n being an integer greater or equal than 2. Step 330 is performed by the test module 114 executed by the processing unit 110 of the computing device 100.

The determination may be implemented in different manners. For example, the determination is performed by reading the initial series of n consecutive values from the memory 120, where it was previously stored. Alternatively, the determination is performed by receiving the initial series of n consecutive values from a remote computing device (not represented in the Figures) via the communication interface 130. Alternatively, the determination is performed by receiving the initial series of n consecutive values from a user via the user interface 140.

Following step 330, the method 300 performs one or more iteration of an iterative process comprising steps 335, 340, 345 and 350.

The method 300 comprises the step 335 of executing the neural network inference engine 112. The neural network inference engine 112 implements a neural network using the predictive model (stored in the memory 120 at step 320) for inferring one or more output parameter based on input parameters. The one or more output parameter comprises a next value of the input variable. The input parameters comprise the series of n consecutive values of the input variable. Step 335 is performed by the processing unit 110 of the computing device 100.

The method 300 comprises the step 340 of executing the instructions of the target software 122 using the next value of the input variable (inferred at step 335) to calculate a corresponding next value of the output variable. Step 340 is performed by (under the control of) the test module 114 executed by the processing unit 110 of the computing device 100.

The method 300 comprises the step 345 of processing the next value of the output variable (calculated at step 340). Step 345 is performed by the test module 114 executed by the processing unit 110 of the computing device 100.

The processing of the next value of the output variable may take various forms. One example of processing comprises determining if a condition is met based (at least) on the next value of the output variable. For instance, the condition is met if the next value of the output variable reaches a threshold (e.g. greater than a pre-defined value, lower than a pre-defined value, within a range of values, outside a range of values, etc.). If the condition is met, one or more action (which is outside the scope of the present disclosure) is performed. Furthermore, the iteration process may be interrupted when the condition is met, or may continue even if the condition is met.

The method 300 comprises the step 350 of updating the series of n consecutive values of the input variable. The update consists in removing the first value among the series of n consecutive values and adding the next value as the last value of the series of n consecutive values. Step 350 is performed by the test module 114 executed by the processing unit 110 of the computing device 100.

Following is a detailed description of the first three iterations of the iteration process performed by the method 300.

For the first iteration of the iterative process, the series of n consecutive values of the input variable consists of (x₁), (x₂) . . . (xₙ) (they are determined at step 330). The next value of the input variable consists of (xₙ₊₁). The updated series of n consecutive values of the input variable consists of (x₂), (x₃) . . . (xₙ₊₁).

For the second iteration of the iterative process, the series of n consecutive values of the input variable consists of (x₂), (x₃) . . . (xₙ₊₁). The next value of the input variable consists of (xₙ₊₂). The updated series of n consecutive values of the input variable consists of (x₃), (x₄) . . . (xₙ₊₂).

For the third iteration of the iterative process, the series of n consecutive values of the input variable consists of (x₃), (x₄) . . . (xₙ₊₂). The next value of the input variable consists of (xₙ₊₃). The updated series of n consecutive values of the input variable consists of (x₄), (x₅) . . . (xₙ₊₃).

More generally, for the i^{th} iteration of the iterative process, the series of n consecutive values of the input variable consists of (xᵢ), (xᵢ₊₁) . . . (xᵢ₊ₙ₋₁). The next value of the input variable consists of (xᵢ₊ₙ). The updated series of n consecutive values of the input variable consists of (xᵢ₊₁), (xᵢ₊₂), . . . , (xᵢ₊ₙ).

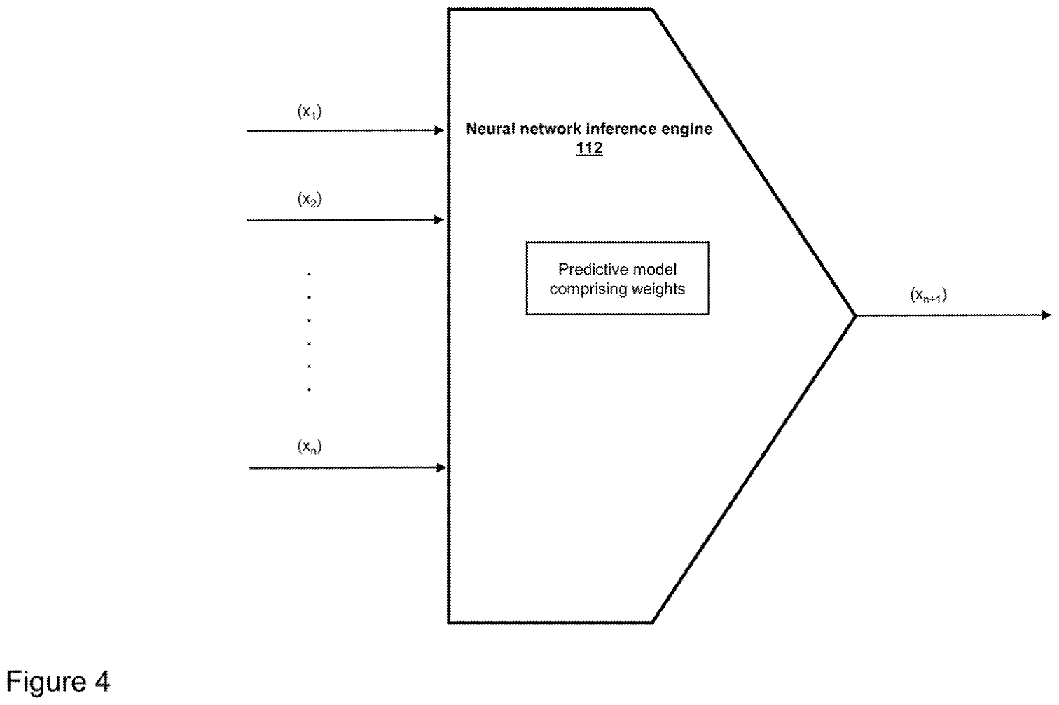

Reference is now made concurrently to FIGS. 3A, 3B and 4. FIG. 4 illustrates the input parameters and the one or more output parameter used by the neural network inference engine 112 when performing step 335. As mentioned previously, the input parameters include the series of n consecutive values of the input variable. The one or more output parameter includes the next value of the input variable. For illustration purposes, FIG. 4 illustrates the first iteration of the iterative process. Although not represented in FIG. 4 for simplification purposes, the neural network inference engine 112 may use additional input parameter(s) and/or additional output parameter(s).

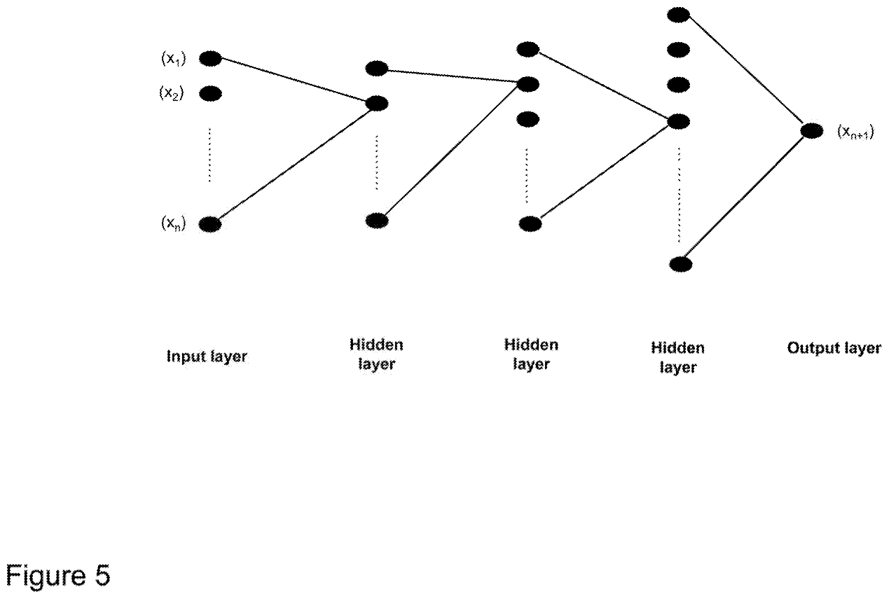

In a first implementation illustrated in FIG. 5, the neural network inference engine 112 implements a neural network comprising an input layer, followed by one or more intermediate hidden layer, followed by an output layer; where the hidden layers are fully connected. The input layer comprises at least n neurons for receiving the input parameters, which comprise the n current values of the input variable (e.g. (xᵢ), (x₂) . . . (xₙ)). The output layer comprises at least one neuron for outputting the one or more output parameter, which comprises the next value of the input variable (e.g. (xₙ₊₁)). For illustration purposes, FIG. 5 illustrates the first iteration of the iterative process.

A layer L being fully connected means that each neuron of layer L receives inputs from every neurons of layer L-1 and applies respective weights to the received inputs. By default, the output layer is fully connected to the last hidden layer.

The generation of the output parameters based on the input parameters using weights allocated to the neurons of the neural network is well known in the art for a neural network using only fully connected hidden layers. The architecture of the neural network, where each neuron of a layer (except for the first layer) is connected to all the neurons of the previous layer is also well known in the art.

In a second implementation not represented in the Figures, the neural network inference engine 112 implements a Long Short-Term Memory (LSTM) neural network. LSTM neural networks are a particular type of neural networks well adapted to particular use cases, including time series prediction.

An LSTM neural network operates in an iterative manner. The output parameter(s) when executing the LSTM neural network at the i^{th} iteration not only depends on the input parameters of the LSTM neural network at the i^{th} iteration, but also depends on the execution of the LSTM neural network at previous iterations (e.g. i−1, i−2, etc.). Thus, the input parameters of the LSTM neural network at previous iterations (e.g. i−1, i−2, etc.) have an impact on the output parameter(s) when executing the LSTM neural network at the i^{th} iteration.

Various implementations of a LSTM neural network are well known in the art. The most common implementation relies on a memory cell, to which information is added or removed via gates (e.g. an input gate, an output gate and a forget gate). The memory cell acts as a memory for the LSTM neural network.

At the i^{th} iteration, the LSTM neural network receives the input parameters, which comprise the n current values of the input variable at the i^{th} iteration ((xᵢ), (xᵢ₊₁) . . . (xᵢ₊ₙ₋₁)). The LSTM neural network outputs the one or more output parameter, which comprises the next value of the input variable (xᵢ₊ₙ). As mentioned previously, the previous values (xᵢ₋₁), (xᵢ₋₂), etc., also have an influence on the value of (xᵢ₊ₙ).

The predictive model comprises one or more parameter of the LSTM functionality of the neural network (e.g. parameters related to the memory cell and gates).

In a third implementation not represented in the Figures, the neural network inference engine 112 implements a neural network comprising an input layer, followed by one 1 D convolutional layer, optionally followed by a pooling layer.

This third implementation is compatible with the aforementioned first and second implementations. Thus, the neural network described in the first and second implementations may include the 1D convolutional layer and the optional pooling layer described in this third implementation.

The input layer comprises at least one neuron for receiving a one-dimension matrix comprising the series of n consecutive values of the input variable. For example, at the i^{th} iteration, the one-dimension matrix consists of [(xᵢ), (xᵢ₊₁) (xᵢ₊ₙ₋₁)]. The input layer is followed by the 1 D convolutional layer, which applies a 1 D convolution to the one-dimension matrix using a one-dimension filter of size lower than n.

The 1D convolutional layer is optionally followed by the pooling layer for reducing the size of the resulting matrix generated by the 1 D convolutional layer. Various algorithms (e.g. maximum value, minimum value, average value, etc.) can be used for implementing the pooling layer, as is well known in the art (a one-dimension filter of given size is also used by the pooling layer).

The 1D convolutional layer and optional pooling layer are followed by additional layers, such as standard fully connected hidden layers as described in the aforementioned first implementation, by layers implementing a LSTM functionality as described in the aforementioned second implementation, etc.

The predictive model comprises parameter(s) defining the 1D convolutional layer (e.g. the size of the one-dimension filter) and the optional pooling layer.

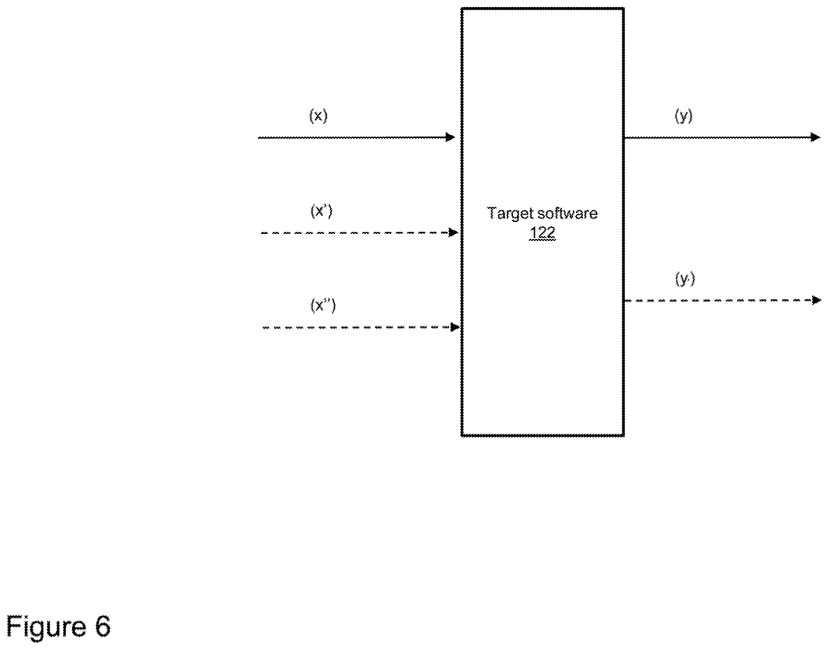

Reference is now made concurrently to FIGS. 3A, 3B and 6. FIG. 6 illustrates the one or more input variable and the one or more output variable of the target software 122.

The one or more input variable includes at least the aforementioned input variable (x). For example, as mentioned previously, at the i^{th} iteration of the method 300, the value of the input variable (x) used as input of the target software 122 is (xᵢ₊ₙ). Optionally, the target software 122 has at least one additional input variable, in addition to input variable (x). For illustration purposes only, FIG. 6 represents the target software 122 having two additional input variables (x′) and (x″).

The one or more output variable includes at least the aforementioned output variable (y). For example, as mentioned previously, at the i^{th} iteration of the method 300, the value of the output variable (y) calculated by the target software 122 is (yᵢ₊ₙ). The calculation of (yᵢ₊ₙ) is based at least on the value of (xᵢ₊ₙ). Optionally, the target software 122 has at least one additional output variable, in addition to output variable (y). For illustration purposes only, FIG. 6 represents the target software 122 having one additional output variables (y′).

The calculation of (y) by the target software 122 (at step 340 of the method 300) is based on the value of (x), and optionally on any combination of (x′) and (x″). The calculation of (y′) by the target software 122 is based on any combination of (x), (x′) and (x″).

The determination of the value of the additional input variable(s) (e.g. (x′) or (x″)) may vary. For example, the input variable (x′) has a constant value at each iteration of the method 300. Alternatively, the input variable (x′) takes a random value at each iteration of the method 300. Alternatively, the input variable (x′) takes a pre-determined (and not constant) value at each iteration of the method 300.

In another exemplary implementation, the value of the input variable (x′) is determined in a manner similar to the input variable (x). In this case, steps 305-310-315-320-330-335-350 of the method 300 are also applied to the input variable (x′). A first predictive model is used by the neural network inference engine 112 for iteratively determining the next value of the input variable (x), and a second predictive model is used by the neural network inference engine 112 for iteratively determining the next value of the input variable (x′). More generally, any input variable of the target software 122 can be iteratively determined by applying steps 305-310-315-320-330-335-350 of the method 300.

In the case where the target software 122 generates several output variables, step 340 of the method 300 calculates the respective values of the several output variables. Then, step 345 of the method 300 may be applied to at least one additional output variable (e.g. (y′)), in addition to output variable (y).

FIG. 6 illustrates an example where the target software 122 generates the output variable (y) mentioned in the method 300, and the additional output variable (y′). At each iteration of step 340 of the method 300, the values of the output variables (y) and (y′) are calculated. Then, at each iteration of step 345 of the method 300, the values of the output variables (y) and (y′) are processed. For example, a determination is made whether a condition is met based on the values of the output variables (y) and (y′) (e.g. the value of (y) reaches a first threshold AND the value of (y′) reaches a second threshold, the value of (y) reaches a first threshold OR the value of (y′) reaches a second threshold, etc.).

In an exemplary use case, the method 300 is used in the context of environment control systems. The input variable (x) is an environmental characteristic value. Examples of environmental characteristic values include a temperature, a humidity level, a carbon dioxide (CO2) level, a lighting level, etc. In the case where the target software 122 uses a plurality of input variables, a combination of environmental characteristic values can be used as inputs. The environmental characteristic value represents a measurement of the environmental characteristic (e.g. a temperature measured in a room). Alternatively or complementarily, at least one of the input variables represents a target value for an environmental characteristic (e.g. a target temperature for a room).

For example, the input variable (x) is a measured temperature and the input variable (x′) is a measured humidity level. In another example, the input variable (x) is a measured temperature and the input variable (x′) is a target temperature. In still another example, the input variable (x) is a measured temperature, the input variable (x′) is a target temperature, and the input variable (x″) is a measured humidity level. In these three examples, the method 300 is used for predicting the evolution of the measured temperature over time, using an initial set of n measured temperatures T₁, T₂, . . . Tₙ determined at step 330 of the method 300.

The output variable (y) is a command for controlling a controlled appliance. Examples of commands include a value of the speed of a fan included in the controlled appliance, a value of the pressure generated by a compressor included in the controlled appliance, a value of the rate of an airflow of a valve included in the controlled appliance, etc. In the case where the target software 122 generates a plurality of output variables, a combination of commands for controlling the controlled appliance can be generated as outputs. Examples of a controlled appliance include a heating, ventilating, and/or air-conditioning (HVAC) appliance, a Variable Air Volume appliance, etc. The one or more output variable of the target software 122 is not used for controlling appliances of a real environment control system. However, the one or more output variable may be used by a simulator of a real environment control system, to test the impact of the one or more output variable on simulated controlled appliance(s).

The method 300 can be used for simulating a real environment control system, where an environment controller executes the target software 122. The environment controller receives one or more environmental characteristic value from respective sensor(s). The one or more environmental characteristic value is used as input(s) of the target software 122. The execution of the target software 122 by the environment controller generates one or more command, which are used by the environment controller for controlling one or more controlled appliance.

Reference is now made concurrently to FIGS. 1, 3A, 3B and 6 for describing the training phase of the neural network. The training phase performed by the neural network training engine 211 of the training server 200 (when performing step 305 of the method 300) is well known in the art.

The neural network implemented by the neural network training engine 211 corresponds to the neural network implemented by the neural network inference engine 112 (same number of layers, same number of neurons per layer, etc.). Thus, the inputs and output(s) of the neural network training engine 211 are the same as those previously described for the neural network inference engine 112. The training phase consists in generating the predictive model that is used during the operational phase by the neural network inference engine 112. The predictive model generally includes the number of layers, the number of neurons per layer, and the weights associated to the neurons of the fully connected hidden layers. The values of the weights are automatically adjusted during the training phase. Furthermore, during the training phase, the number of layers and the number of neurons per layer can be adjusted to improve the accuracy of the model.

Various techniques well known in the art of neural networks are used for performing (and improving) the generation of the predictive model, such as forward and backward propagation, usage of bias in addition to the weights (bias and weights are generally collectively referred to as weights in the neural network terminology), reinforcement training, etc.

In the case where the neural network includes a LSTM functionality, parameters of the LSTM functionality are also defined and optionally adapted during the training phase. The parameters of the LSTM functionality are included in the predictive model.

In the case where a convolutional layer is used for the neural network, parameters of the convolutional layer are also defined and optionally adapted during the training phase. For example, the size of the filter used for the convolution is determined during the training period. The parameters of the convolutional layer are included in the predictive model.

Similarly, in the case where a pooling layer is used for the neural network, parameters of the pooling layer are also defined and optionally adapted during the training phase. For example, the algorithm and the size of the filter used for the pooling operation are determined during the training period. The parameters of the polling layer are included in the predictive model.

The training phase starts with the generation of an initial predictive model, which comprises defining a number of layers of the neural network, a number of neurons per layer, the initial value for the weights of the neural network, etc.

The definition of the number of layers and the number of neurons per layer is performed by a person highly skilled in the art of neural networks. Different algorithms (well documented in the art) can be used for allocating an initial value to the weights of the neural network. For example, each weight is allocated a random value within a given interval (e.g. a real number between −0.5 and +0.5), which can be adjusted if the random value is too close to a minimum value (e.g. −0.5) or too close to a maximum value (e.g. +0.5).

Training data are collected for executing the training phase of the neural network, to generate the predictive model which will be used during the operational phase. The training data include a plurality of sets of input parameters and corresponding output parameter(s) of the neural network. The training of a neural network is well known in the art, and is out of the scope of the present disclosure.

In the case where the input variable (x) of the target software 122 is an environmental characteristic value, a sensor is used for measuring consecutive values of the environmental characteristic in a target environment (e.g. in a room of a building). For example, the input variable (x) is a measured temperature and a temperature sensor measures a plurality of consecutive temperatures in a room. The temperature sensor transmits the measured temperatures to the training server 200. The training server 200 uses the measured temperatures to generate a plurality of sets of input parameters (comprising a plurality of series of n consecutive temperature Tᵢ, Tᵢ₊₁, Tᵢ₊ₙ₋₁) and corresponding output parameter(s) (comprising the next temperature in the series Tᵢ₊ₙ). The neural network training engine 211 executed by the training server 200 uses the plurality of sets of input parameters and output parameter(s) to improve the predictive model.

At the end of the training phase, the neural network is considered to be properly trained. An operational predictive model (ready to be used by the neural network inference engine 112) is transmitted to the computing device 100, as per step 310 of the method 300.

FIG. 1 represents an implementation where the training server 200 and the computing device 100 are two independent computing devices. In an alternative implementation, the functionalities of the training server 200 are integrated to the computing device 100. For instance, the neural network training engine 211 is executed by the processing unit 110 of the computing device 100.

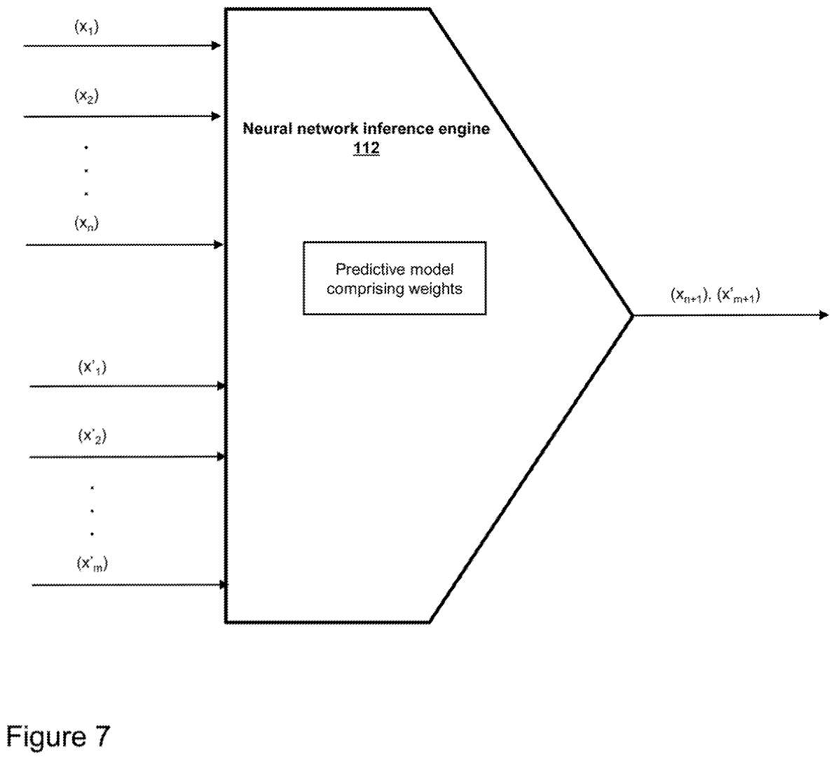

Reference is now made concurrently to FIGS. 1, 3A, 3B, 6 and 7, where FIG. 7 represents the neural network inference engine 112 operating on two series of consecutive values of the respective input variables (x) and (x′) of the target software 122. The predictive model has been trained for receiving as input parameters a series of n consecutive values of the input variable (x) and a series of m consecutive values of the input variable (x′), to generate as output parameters the next value of the input variable (x) and the next value of the output variable (x′)

At the i^{th} iteration of the previously described iterative process, the series of n consecutive values of the input variable (x) consists of (xᵢ), (xᵢ₊₁) . . . (xᵢ₊ₙ₋₁). The next value of the input variable (x) consists of (xᵢ₊ₙ). The updated series of n consecutive values of the input variable (x) consists of (xᵢ₊₁), (xᵢ₊₂) (xᵢ₊ₙ), which is used as input parameters of the neural network inference engine 112 at the next iteration i+1. Similarly, at the i^{th} iteration of the previously described iterative process, the series of m consecutive values of the input variable (x′) consists of (x′ᵢ), (xᵢ₊₁) . . . (x′ᵢ₊ₘ₋₁). The next value of the input variable (x′) consists of (x′ᵢ₊ₘ). The updated series of m consecutive values of the input variable (x′) consists of (x′ᵢ₊₁), (xᵢ₊₂) . . . (x′ᵢ₊ₘ), which is used as input parameters of the neural network inference engine 112 at the next iteration i+1. FIG. 7 represents the first iteration (i=1) of the iterative process.

For example, in the case of an environment control system, the two input variables consist of two environmental characteristic values (e.g. (x) is a measured temperature and (x′) is a measured humidity level). In this case, the series generally have the same number of values (m=n) for each environmental characteristic value (x) and (x′).

The neural network implemented by the neural network inference engine 112 may take several forms. In a first implementation, the neural network is a standard neural network similar to the one represented in FIG. 5. The neural network comprises an input layer, followed by one or more intermediate hidden layer, followed by an output layer; where the hidden layers are fully connected.

In a second implementation, the neural network includes a LSTM functionality, which is applied to both series of values of the input variables (x) and (x′). At the i^{th} iteration, the LSTM neural network receives the input parameters, which comprise the n current values of the input variable (x) at the i^{th} iteration ((xᵢ), (xᵢ₊₁) . . . (xᵢ₊ₙ₋₁)) and the m current values of the input variable (x′) at the i^{th} iteration ((x′i), (x′ᵢ₊₁) . . . (xᵢ₊ₘ₋₁)). The LSTM neural network outputs the output parameters, which comprise the next value of the input variable (x) (xᵢ₊ₙ) and the next value of the input variable (x)′ (x′ᵢ₊ₘ). As mentioned previously, the previous values (xᵢ₋₁), (xᵢ₋₂), etc., of the input variable (x) also have an influence on the value of (xᵢ₊ₙ) and the previous values (x′ᵢ₋₁), (x′ᵢ₋₂), etc., of the input variable (x′) also have an influence on the value of (x′ᵢ₊ₘ).

In a third implementation, the neural network comprises an input layer, followed by one 1D convolutional layer, optionally followed by a pooling layer. This third implementation is compatible with the aforementioned first and second implementations. Thus, the neural network described in the first and second implementations may include the 1D convolutional layer and the optional pooling layer described in this third implementation.

The input layer comprises one neuron for receiving a first one-dimension matrix comprising the series of n consecutive values of the input variable (x) and one neuron for receiving a second one-dimension matrix comprising the series of m consecutive values of the input variable (x′). For example, at the i^{th} iteration, the first one-dimension matrix consists of [(xᵢ), (xᵢ₊₁) . . . (xᵢ₊ₙ₋₁)] and the second one-dimension matrix consists of [(x′ᵢ)), (x′ᵢ₊₁) . . . (x′ᵢ₊ₘ₋₁)] The input layer is followed by the 1D convolutional layer, which applies a first 1D convolution to the first one-dimension matrix using a one-dimension filter of size lower than n. The 1D convolutional layer also applies a second 1D convolution to the second one-dimension matrix using a one-dimension filter of size lower than m. The 1D convolutional layer is optionally followed by the pooling layer for reducing the size of the two resulting matrixes generated by the 1D convolutional layer. The 1D convolutional layer and optional pooling layer are followed by additional layers, such as standard fully connected hidden layers as described in the aforementioned first implementation, by layers implementing a LSTM functionality as described in the aforementioned second implementation, etc.

In a fourth implementation, the neural network comprises an input layer, followed by one 2D convolutional layer, optionally followed by a pooling layer. This fourth implementation is compatible with the aforementioned first and second implementations. Thus, the neural network described in the first and second implementations may include the 2D convolutional layer and the optional pooling layer described in this fourth implementation. In this case, the series have the same number of values (m=n) for each environmental characteristic value (x) and (x′).

The input layer comprises one neuron for receiving a two-dimensions (n*2) matrix comprising the series of n consecutive values of the input variable (x) and the series of n consecutive values of the input variable (x′). For example, at the i^{th} iteration, the two-dimensions matrix consists of [(xᵢ), (xᵢ₊₁) . . . (xᵢ₊ₙ₋₁), (x′i), (x′ᵢ₊₁) . . . (x′ᵢ₊ₙ₋1)] The input layer is followed by the 2D convolutional layer, which applies a 2D convolution to the n*2 input matrix using a two-dimensions filter of size lower than n*2. The 2D convolutional layer is optionally followed by the pooling layer for reducing the size of the resulting matrix generated by the 2D convolutional layer. The 2D convolutional layer and optional pooling layer are followed by additional layers, such as standard fully connected hidden layers as described in the aforementioned first implementation, by layers implementing a LSTM functionality as described in the aforementioned second implementation, etc.

The usage of the 1D convolutional layer (third implementation) allows to detect patterns between the series of values of the first input variable (x), independently of patterns between the series of values of the second input variable (x′).

The usage of the 2D convolutional layer (fourth implementation) allows to detect patterns between the series of values of the first input variable (x) and the series of values of the second input variable (x′) in combination.

When using the 2D convolutional layer, the inputs of the neural network usually need to be normalized before processing by the 2D convolutional layer. Normalization consists in adapting the input data (the series of values of the input variables (x) and (x′)), so that all input data have the same reference. The input data can then be compared one to the others. Normalization may be implemented in different ways, such as: bringing all input data between 0 and 1, bringing all input data around the mean of each feature (for each input data, subtract the mean and divide by the standard deviation on each feature individually), etc. The effect of normalization is smoothing the image for the 2D convolution and preventing to always take the same feature at the pooling step.

The method 300 can be adapted to take into consideration the neural network inference engine 112 operating with the input parameters represented in FIG. 7. For this purpose, an additional step similar to step 330 is added, consisting in determining an initial series of m consecutive values (x′₁), (x′₂) . . . (x′ₘ) of the input variable (x′). Step 335 is adapted to take into consideration that at the i^{th} iteration, the input parameters of the neural network include the series of m consecutive values of the input variable (x′) consisting of (>ᵢ), (x′ᵢ₊₁) . . . (x′ᵢ₊ₘ₋₁) and the output parameters include the next value of the input variable (x′) consisting of (x′ᵢ₊ₘ). Step 340 is adapted to take into consideration the next value of the input variable (x′) when executing the target software 122 for calculating the output variable. An additional step similar to step 350 is added, consisting in updating the series of m consecutive values of the input variable (x′) by removing the first value among the series of m consecutive values and adding the next value as the last value of the series of m consecutive values.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A computing device comprising:
memory for storing:
a predictive model comprising weights of a neural network; and
instructions of a software, the software using an input variable for calculating an output variable; and
a processing unit comprising one or more processor configured to:
determine an initial series of n consecutive values (x₁), (x₂) . . . (xₙ) of the input variable, n being an integer greater or equal than 2; and
perform one or more iteration of an iterative process, the iterative process including:
executing a neural network inference engine, the neural network inference engine implementing a neural network using the predictive model for inferring one or more output parameter based on input parameters, the one or more output parameter comprising a next value of the input variable, the input parameters comprising the series of n consecutive values of the input variable;
executing the instructions of the software using the next value of the input variable to calculate a corresponding next value of the output variable; and
updating the series of n consecutive values of the input variable by removing the first value among the series of n consecutive values and adding the next value as the last value of the series of n consecutive values.

2. The computing device of claim 1, wherein for the first iteration of the iterative process, the series of n consecutive values of the input variable consists of (x₁), (x₂) . . . (xₙ); the next value of the input variable consists of (xₙ₊₁); and the updated series of n consecutive values of the input variable consists of (x₂), (x₃) . . . (xₙ₊₁).

3. The computing device of claim 2, wherein for the second iteration of the iterative process, the series of n consecutive values of the input variable consists of (x₂), (x₃) . . . (xₙ₊₁); the next value of the input variable consists of (xₙ₊₂); and the updated series of n consecutive values of the input variable consists of (x₃), (x₄) . . . (xₙ₊₂).

4. The computing device of claim 1, wherein the iterative process further includes determining that a condition is met based at least on the next value of the output variable.

5. The computing device of claim 4, wherein the instructions of the software calculate at least one additional output variable, the processing unit executes the instructions of the software to calculate the corresponding next value of the output variable and a value of the additional output variable, and the determination that a condition is met is also based on the value of the additional output variable.

6. The computing device of claim 1, wherein the instructions of the software use at least one additional input variable for calculating the output variable, and the processing unit executes the instructions of the software using the next value of the input variable and a value of the at least one additional input variable to calculate the corresponding next value of the output variable.

7. The computing device of claim 1, wherein the input variable consists of a temperature, a humidity level, a carbon dioxide (CO2) level, or a lighting level.

8. The computing device of claim 1, wherein the output variable consists of a command for controlling a controlled appliance of an environment control system.

9. The computing device of claim 1, wherein the neural network implemented by the neural network inference engine comprises an input layer, followed by fully connected hidden layers, followed by an output layer; the input layer comprising neurons respectively receiving the series of n consecutive values of the input variable; the output layer comprising a neuron outputting the next value of the input variable; the weights of the predictive model being applied to the fully connected hidden layers.

10. The computing device of claim 1, wherein the neural network implemented by the neural network inference engine is a Long Short-Term Memory (LSTM) neural network receiving the series of n consecutive values of the input variable and outputting the next value of the input variable, the predictive model further comprising one or more parameter defining a LSTM functionality of the neural network.

11. The computing device of claim 1, wherein the neural network implemented by the neural network inference engine comprises a one-dimensional convolutional layer for applying a one-dimensional convolution to a one-dimension matrix comprising the series of n consecutive values of the input variable, the predictive model further comprising one or more parameter defining the one-dimensional convolutional layer.

12. A method using a neural network to predict values of an input variable of a software, the method comprising:
storing in a memory of a computing device a predictive model comprising weights of the neural network;
storing in the memory of the computing device instructions of the software, the software using the input variable for calculating an output variable;
determining by a processing unit of the computing device an initial series of n consecutive values (x₁), (x₂) . . . (xₙ) of the input variable, n being an integer greater or equal than 2; and
performing by the processing unit of the computing device one or more iteration of an iterative process, the iterative process including:
executing a neural network inference engine, the neural network inference engine implementing the neural network using the predictive model for inferring one or more output parameter based on input parameters, the one or more output parameter comprising a next value of the input variable, the input parameters comprising the series of n consecutive values of the input variable;
executing the instructions of the software using the next value of the input variable to calculate a corresponding next value of the output variable; and
updating the series of n consecutive values of the input variable by removing the first value among the series of n consecutive values and adding the next value as the last value of the series of n consecutive values.

13. The method of claim 12, wherein for the first iteration of the iterative process, the series of n consecutive values of the input variable consists of (x₁), (x₂) . . . (xₙ); the next value of the input variable consists of (xₙ₊₁); and the updated series of n consecutive values of the input variable consists of (x₂), (x₃) . . . (xₙ₊₁).

14. The method of claim 13, wherein for the second iteration of the iterative process, the series of n consecutive values of the input variable consists of (x₂), (x₃) (xₙ₊₁); the next value of the input variable consists of (xₙ₊₂); and the updated series of n consecutive values of the input variable consists of (x₃), (x₄) . . . (xₙ₊₂).

15. The method of claim 12, wherein the iterative process further includes determining that a condition is met based at least on the next value of the output variable.

16. The method of claim 15, wherein the instructions of the software calculate at least one additional output variable, the processing unit executes the instructions of the software to calculate the corresponding next value of the output variable and a value of the additional output variable, and the determination that a condition is met is also based on the value of the additional output variable.

17. The method of claim 12, wherein the instructions of the software use at least one additional input variable for calculating the output variable, and the processing unit executes the instructions of the software using the next value of the input variable and a value of the at least one additional input variable to calculate the corresponding next value of the output variable.

18. The method of claim 12, wherein the input variable consists of a temperature, a humidity level, a carbon dioxide (CO2) level, or a lighting level.

19. The method of claim 12, wherein the output variable consists of a command for controlling a controlled appliance of an environment control system.

20. The method of claim 12, wherein the neural network implemented by the neural network inference engine comprises an input layer, followed by fully connected hidden layers, followed by an output layer; the input layer comprising neurons respectively receiving the series of n consecutive values of the input variable; the output layer comprising a neuron outputting the next value of the input variable; the weights of the predictive model being applied to the fully connected hidden layers.

21. The method of claim 12, wherein the neural network implemented by the neural network inference engine is a Long Short-Term Memory (LSTM) neural network receiving the series of n consecutive values of the input variable and outputting the next value of the input variable, the predictive model further comprising one or more parameter defining a LSTM functionality of the neural network.

22. The method of claim 12, wherein the neural network implemented by the neural network inference engine comprises a one-dimensional convolutional layer for applying a one-dimensional convolution to a one-dimension matrix comprising the series of n consecutive values of the input variable, the predictive model further comprising one or more parameter defining the one-dimensional convolutional layer.

23. A non-transitory computer program product comprising instructions executable by a processing unit of a computing device, the execution of the instructions by the processing unit providing for using a neural network to predict values of an input variable of a software by:
storing in a memory of the computing device a predictive model comprising weights of the neural network;
storing in the memory of the computing device instructions of the software, the software using the input variable for calculating an output variable;
determining an initial series of n consecutive values (x₁), (x₂) . . . (xₙ) of the input variable, n being an integer greater or equal than 2; and
performing one or more iteration of an iterative process, the iterative process including:
executing a neural network inference engine, the neural network inference engine implementing the neural network using the predictive model for inferring one or more output parameter based on input parameters, the one or more output parameter comprising a next value of the input variable, the input parameters comprising the series of n consecutive values of the input variable;
executing the instructions of the software using the next value of the input variable to calculate a corresponding next value of the output variable; and
updating the series of n consecutive values of the input variable by removing the first value among the series of n consecutive values and adding the next value as the last value of the series of n consecutive values.
